(19) United States
(12) Patent Application Publication
(10) Pub. No.: US 2008/0189298 A1
(43) Pub. Date: Aug. 7, 2008

(54) METHOD AND APPARATUS FOR WIRELESS ACCESS TO PERSONALIZED MULTIMEDIA AT ANY LOCATION

(76) Inventor: Steve Cha, Franklin Lakes, NJ (US)

Correspondence Address: CHA & REITER, LLC, 210 ROUTE 4 EAST STE 103, PARAMUS, NJ, 07652, US

(21) Appl. No.: 12/101,189

(22) Filed: Apr. 11, 2008

Related U.S. Application Data
(60) Provisional application No. 61/041,610, filed on Apr. 2, 2008.

(51) Int. Cl. G06F 17/30

(52) U.S. Cl. 707/10; 707/E17.001

(57) ABSTRACT

A system and method for providing an online personalized inventory of authorized content that is accessible from virtually any location by a wirelessly connected user. A server in communication with a personalized database is accessible from a plurality of locations via RF, permits automatic viewing of an authorized library, and/or select portions for additional purchase and download. Retrieval of a personalized catalog of authorized content for enjoyment while traveling, etc. is effectuated without having to “sync” or “resync” with a home or base computer, or worry about backing up the collection. The system permits adding to the online personalized collection by purchasing additional material, without having to upload the purchases to a base or home computer, as they are kept track of and maintained by the server. A plurality of player devices can each download portions of the personalized content.

### CROSS REFERENCE TO RELATED APPLICATIONS

This application claims the benefit of U.S. Provisional Application Ser. No. 61/041,610 filed Apr. 2, 2008, the teachings of which are incorporated herein by reference.

### BACKGROUND OF THE INVENTION

1. Field of the Invention

The present invention relates to systems and apparatus to provide a remote access to multimedia files including but not limited to music, music videos, movies, video games, podcasts, etc. More particularly, the present invention relates to personalized multimedia and the ability to access the content of personalized multimedia.

2. Description of the Related Art

Today, there is an ever-increasing amount of content that can be accessed by a computer, handheld phone, personal digital assistant (PDA), or portable terminal. For example, it has now become quite common to store music on one's computer in MP3 format, and/or on a personal portable device such as an i-POD©, telephone, portable terminal, which may be handheld or clipped to one's clothing, or even merely attached to one's ear or eyeglasses, just to name a few of the many possible scenarios.

In recent times there has been an increase in demand for personalized music portfolios. Coupled with increases in storage technology, handheld phones, portable computers, and even devices such as the i-POD© permit a user to listen to their personal selection of music, or watch their personally selected movie or television show.

There are drawbacks to one walking around with a personalized music portfolio on a portable device. First, if the device is lost or damaged, there may be no way to retrieve files that are damaged. Thus, provided that the user has purchased the content from a licensed source, considerable sums of money can be lost. Alternatively, the collection of songs/videos need to be backed up on a home computer, and then possibly copied onto a CD or DVD, just to name to possible storage devices. However, the storage of one's multi-media on a home computer can quickly take up storage on the computer, and without further backup, can be lost if the home computer is damaged.

In addition, sometimes the collection of multimedia content is so large that it cannot all fit on a device such as an i-POD or i-POD Nano©. Therefore, a user has to selectively download or “sync” new or changed content, which often involves plugging the portable device into a USB type port of a personal computer. This process can be extremely cumbersome.

In addition, sometimes a number of family members may share either the same multimedia library, or the same portable device. Thus, multimedia content must be loaded, or reloaded over previously loaded content, and then when another person with access to the device wants to listen/view personalized content, the process has to be performed yet again.

Recent innovations include devices such as a i-POD Touch© allows users to purchase and download additional songs from a WiFi connection to their i-POD. However, the wireless connection is used only to purchase additional songs for the device.

With regard to all of the aforementioned technology offerings, it is still cumbersome to keep one's personal music library stored in a portable device, and there are shortcomings in only storing a fraction of the library on a portable device, as it needs to be linked with one's home computer to “resync” and load different music that has previously been properly paid for and licensed, whether the music is a copy converted into a format such as MP3 from a CD, or a video from a DVD. The ability to purchase additional songs from iTunes does not permit access to the previously authorized multimedia, and also requires one to connect the i-pod Touch to one's home computer to upload the music to one's home or base computer.

### SUMMARY OF THE INVENTION

The present invention provides access to one's personalized multimedia library from virtually any location without having to plug into one's home or base computer, as in conventional devices and systems for accessing and utilizing licensed personal content, such as multimedia.

More particularly, the present invention permits a personalized multi media library or portion thereof to be accessed without the burden of backing up, or uploading after purchasing, as is necessary in conventional systems in which one currently initiates a purchase from a wireless device using services such as i-Tunes, for example. Whereas in the conventional system, the purchaser must at some later date connect the device to his/her home or base computer to upload the content to the home or base computer to have a copy as backup, or in case the user desires to load other content on the device and wishes to remove the purchased content from the device, the present invention keeps either a copy of the personalized library or a list of the authorized files from a plurality of users for accessing a common library.

In one exemplary embodiment, through the use of a server that is accessible at a plurality of locations via RF, the user can automatically view his/her authorized library for a subsequent retrieval, and/or select portions for download and even purchase new selection without having to upload them at a later date.

Accordingly, the present invention provides a personalized wirelessly accessible multimedia library to retrieve a personalized catalog of authorized multimedia for enjoyment while traveling, etc. without having to “sync” or “resync” with a home or base computer, or worry about backing up the collection. Any device with RF capability and multimedia means (such as a thin client device) can wirelessly select and/or receive their personalized music collections from a server and an online database, without having to connect cables or require one to communicate with their home or base computer, which may be inaccessible while on business travel, vacation etc.

In an exemplary aspect of the invention, a user can wirelessly select from a menu of one's personalized music catalog and access or download a selected portion of songs/movies/videos/games/etc., in order to enjoy at any location while roaming, and is not limited to having to dialing in to one's home or base computer to access the content.

According to an exemplary aspect of the invention, the wireless transmission may utilize, for example, one or more of the bands of the 700 MHZ bandwidth that is now slated to be provided for open access and typically penetrates walls. However, any other bandwidth, such as the whitespace between television channels that are currently being studied by the Federal Communications Commission for use in communication between the server and a plurality of users for internet broadband, may also be used. In addition, the teachings of the present invention can be used in other types of frequencies through the spectrum and various types of modulations.

### BRIEF DESCRIPTION OF THE DRAWINGS

The above-mentioned and other features, and advantages of the present invention will become more apparent from the following detailed description when taken in conjunction with the accompanying drawings, in which:

FIG. 1A illustrates an exemplary overview of a system according to the present invention;

FIG. 1B illustrates an exemplary embodiment mobile user device including a player and a detachable interface;

FIG. 1C is an exemplary illustration of a network for wireless access between a handheld mobile user device and a network in communication with the server;

FIG. 1D is an exemplary illustration of a database and an online personalized inventory list of authorized content;

FIG. 2 is an exemplary flowchart of another aspect of a method for providing an online personalized inventory according to the present invention; and

FIG. 3 is an exemplary flowchart of another aspect of a method for providing and adding to an online personalized inventory according to the present invention.

### DETAILED DESCRIPTION

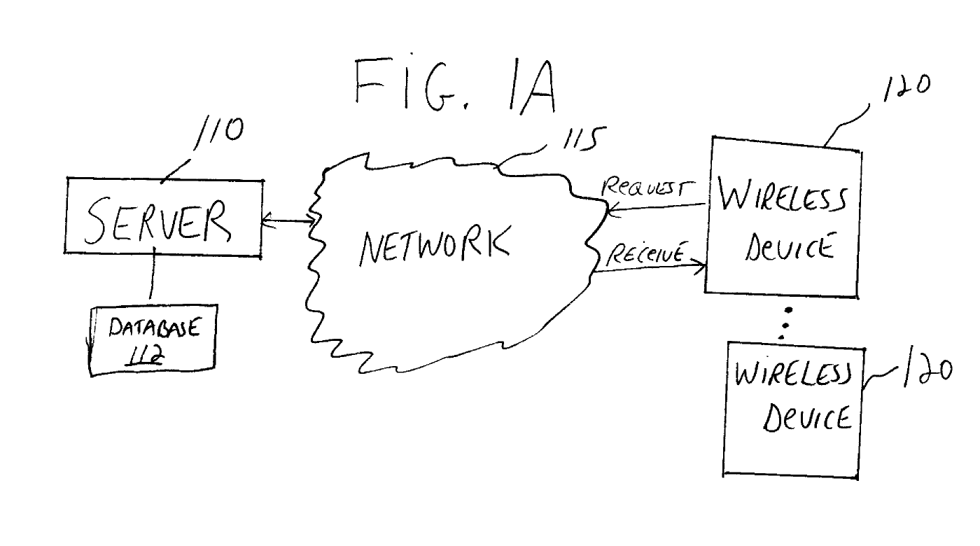

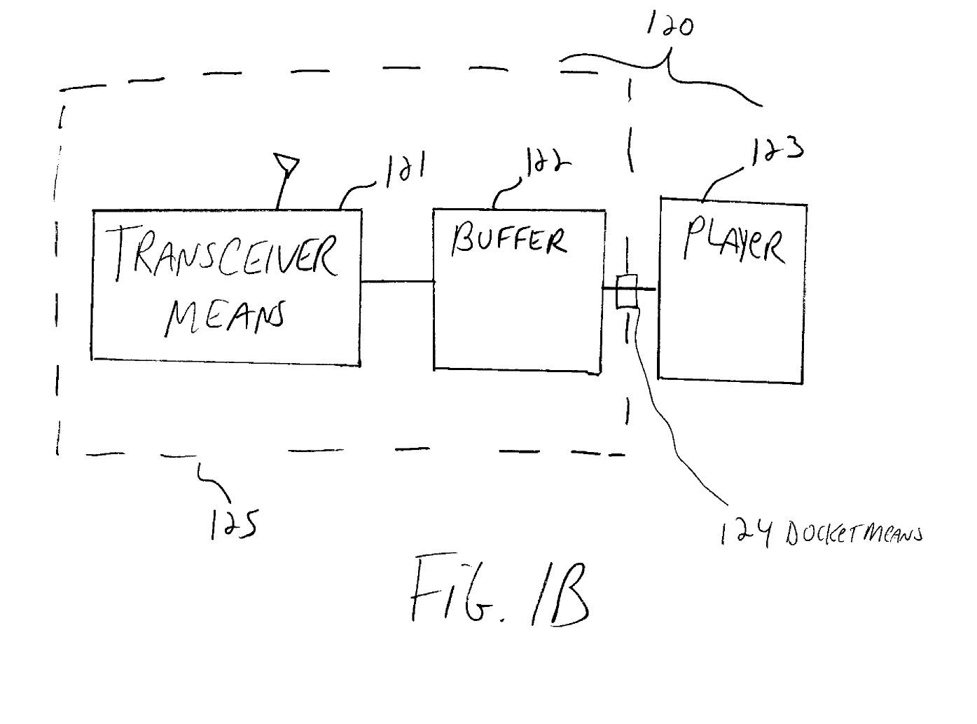

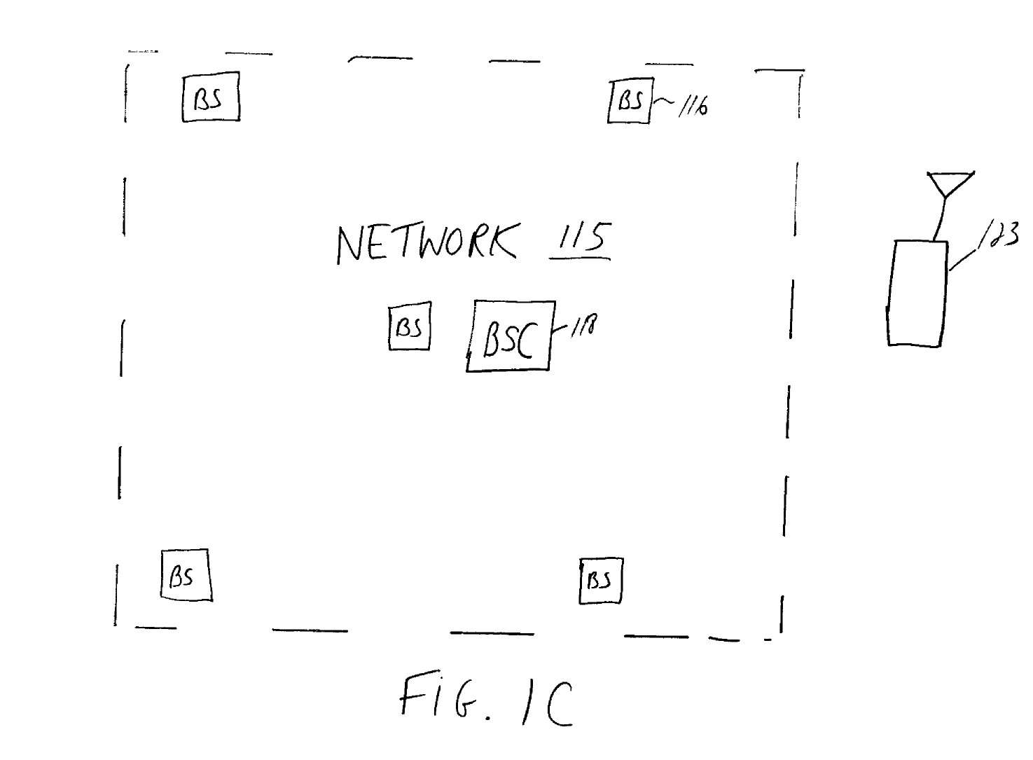

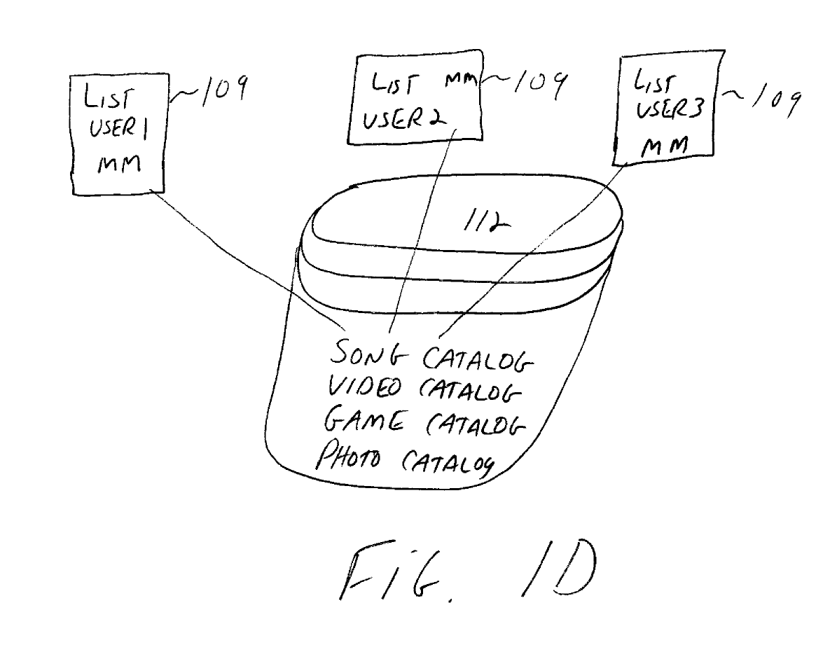

In the following description, for purposes of explanation rather than limitation, specific details are set forth such as the particular architecture, interfaces, techniques, etc., in order to provide a thorough understanding of the method and apparatus for wireless access of online authorized content by a person of ordinary skill in the art. However, it will be apparent to those skilled in the art that the present invention may be practiced in other embodiments which depart from these exemplary embodiments, but are still within the spirit of the invention and the scope of the appended claims. Moreover, for the purpose of clarity, detailed descriptions of well-known devices, circuits, and methods may be omitted so as not to obscure the description of the present invention with unnecessary detail of such well-known devices, circuits and methods. Referring to FIG. 1A, a first exemplary embodiment of an overview of system in which the present invention can operate. In this particular exemplary embodiment, the system may include a server 110, a network 1115 and a wireless device 120. The server 110 can access content from at least one content database 112, and upon verification of authorization, provide the same to the network for transmission to the wireless devices. While the information can be downloaded to the device in a number of ways, one way is via packets or dataframes for transmission by the network to the wireless device 120, including but not limited in any way to, for example, a thin client device. It should be noted a wireless device within the context of this disclosure includes a MP3 player, a dvd player, a lap-top computer, a mobile phone, and other mobile computer devices, such as a personal digital assistant (PDA), a personal communication assistant (PCA), an electronic organizer, or any duplex interactive devices just to name a few possibilities. The server would either store or have access to storage of at least a collection of content, which may include multimedia content stored in database 112. In this context, multimedia content may comprise any type of files that can be viewed or listened to, such as, including but not limited to audio, visual, or audio visual files. The terms audio visual files are not limited to, for example, files that are strictly sound, visual, or a combination of the too, and include any type of file that can be used to generate sound or a visual representation, and/or both. Such files may be subject to compression, such as MP3 files, but there is no restriction to MP3 files and any type of files used to accessible the authorized content can be used.

In the case of multimedia content that is commonly licensed out to members of the public, for example, many people own licensed copies of the Disney movie (Snow White) and many others own a licensed copy of the musical album “Dark Side of the Moon: by Pink Floyd, and it would be inefficient and redundant to store the copy of each over and over. Instead, one way the server may be set up is that the catalog of songs, books, personal files, and movies, for example, would have a multi-media inventory and the “personalized inventory” would be a respective list of each subscribers albums/videos/games etc. that are selectively retrievable according to the list. When additional songs/movies/multimedia files are added to a personalized inventory, an identifier of the additional items would be added to the list and would be selectable be the user for accessing and/or downloading anytime and anywhere RF access is permissible.

FIG. 1B shows an example of a wireless device 120 comprising an interface 125 that may be used according to the present invention. The device 120 may be an integrated transceiver 121 that can receive and transmit wireless communications, as well as download and store (at least temporarily) the downloaded content in a buffer 122. It should be noted that virtually any RF capable device can be used. Such a device is included but not limited to portable terminal, person digital assistant (PDA), cellphone, or thin client device, just to name a few of the many possible devices.

In the example shown in FIG. 1B, transceiver means 121, buffer 122 and a player 123 are all part of one device shown in FIG. 1A, but the player 123 and buffer can also be separate from the transceiver means 121. A docketing means 124 can be arranged in, for example, automobiles, hotels, public places, etc., in which a proprietary or a standard interface can be provided, including but not limited to a Universal Serial Bus (USB), IEE1394, cellphone interface, etc. The docketing means may also wireless connect to a thin client device, such as via Bluetooth or Wifi, for example, and also wirelessly transmit over an RF network to communicate with the server and access the online personalized inventory.

It is to be emphasized and appreciated by a person of ordinary skill in the art that the present invention is not limited a device which includes the device interface discussed above. The transceiver means may, for example, comprise a separately installed device, for example, inside an automobile, and would preferably include some type of storage buffer, such as buffer 122 or in addition to buffer 122, which could be serving as a buffer for the transceiver 121. The player 123 may comprises a totally separate device that is plugged into or docked into the adapter interface in the automobile. Or, a portable storage device, such as a thumbnail type drive might receive the output downloaded and then the portable storage then connected to an interface of the device for loading the player with multimedia.

In addition, it is also within the spirit of the invention that the wireless device interface, when installed in a stationary location (such as, for example, an airport), could receive the communications from the server via a fiber optic line, and then convert the signals into wireless communications, including but not limited to the 700 MHz band, that has been set aside for open access, such as the white space band comprising unused frequencies in the VHF and UHF bands allocated to television transmission by the FCC, typically between the channels and for example, may range anywhere from 54 MHz to 698 MHz. A person of ordinary skill in the art should understand and appreciate that frequencies significantly higher or lower than the aforementioned (meaning both fractions of and multiples of) in other bandwidths, including but not limited to frequencies anywhere within RF or microwave ranges. In addition, with regard to a range or band of frequencies, the transceiver means could possibly receive at one frequency and transmit at another frequency.

FIG. 1C shows one non-limiting example of a series of base stations 116 arranged at intervals to permit coverage throughout a desired area. The base stations would contain the hardware for transmitting and receiving of radio signals, antennas, and are typically controlled by a base station controller 118. However, some or all of the functions can be performed by software, such as software-defined radio. The base stations may also convert information received from the user through the air and convert it to a PCM or TDM interface, for example, and send it to the base station controller 118.

FIG. 1D is one example of the content that may be stored at the server or accessed by the server in response to a request from a user. The content data base may comprise, for example, a relational database, from which a personalized library of files represents, for example, songs, videos, movies, games, and/or any type of multimedia file, with or without sound, etc. are accessed to provide a wireless device 120 with the requested content. While a person of ordinary skill in the art will appreciate that there are a plurality of ways to carry out this function, a series of lists describing the content of a particular owner's personal library would list song titles, albums, artist, movies, etc that are associated with some of the content stored in database 112.

While the lists may be a series of pointers, more personalized items that are not commonly access, such as personalized photos, etc. may also be stored in the database or in a memory module containing the lists.

Upon authenticating the user requesting access, a menu of options can be provided to the user that may include or allow a user to view a menu of all their authorized content, and download selected content now to their wireless device 120. In the case where the wireless device is a thin client device, telephone, portable terminal, etc., the menu would be accessible typically via a browser installed on the device. There could also be some format for displayed programmed into the device.

According to an aspect of the invention, the personalized libraries (or lists of the content making up each of the personalized libraries) are stored online by the server. In association with the database, the content of at least a portion of the personal library is transmitted to the wireless device 120, when requested by user, to display on a menu. In response to a request to download some or all of the personal library to the wireless device 120, either a module containing the personalized library is retrieved, or at least the selected portion of the library is constructed based on the identification of the files in the list for a specific user.

In order to comply with copyright laws, and issues such as Digital Rights Management, the server may check whether a requested item, if selected from a main catalog rather than a personal library, is also authorized (meaning typically paid for and a license granted). If the content is unauthorized, the server can send a message informing the user that such content is not authorized, and may ask the user whether he/she would like to purchase the rights. The same may apply in the case of DRM, where the user has exhausted the number of permissible hours or passes, etc. of accessing the content.

Based on the aforementioned discussion, the invention advantageously permits “on the fly” access to one's personalized multimedia content without the need to personally back up and maintain the files, as such records are kept and maintained at the server. Even more advantageously, new purchases would not have to be “uploaded” to one's base or home computer via, for example, “syncing” the device to determine whether the content on the device matches the content in the library, and uploading the newly authorized content.

According to an exemplary aspect of the present invention, the network would preferably provide capability across the country. However, in some areas, it is possible that the device uses another network in a roaming type scenario. Or there may be a number of Internet Service Providers or cellular telephone or personal digital assistant service providers operating on certain frequencies that can be accessed by the wireless device.

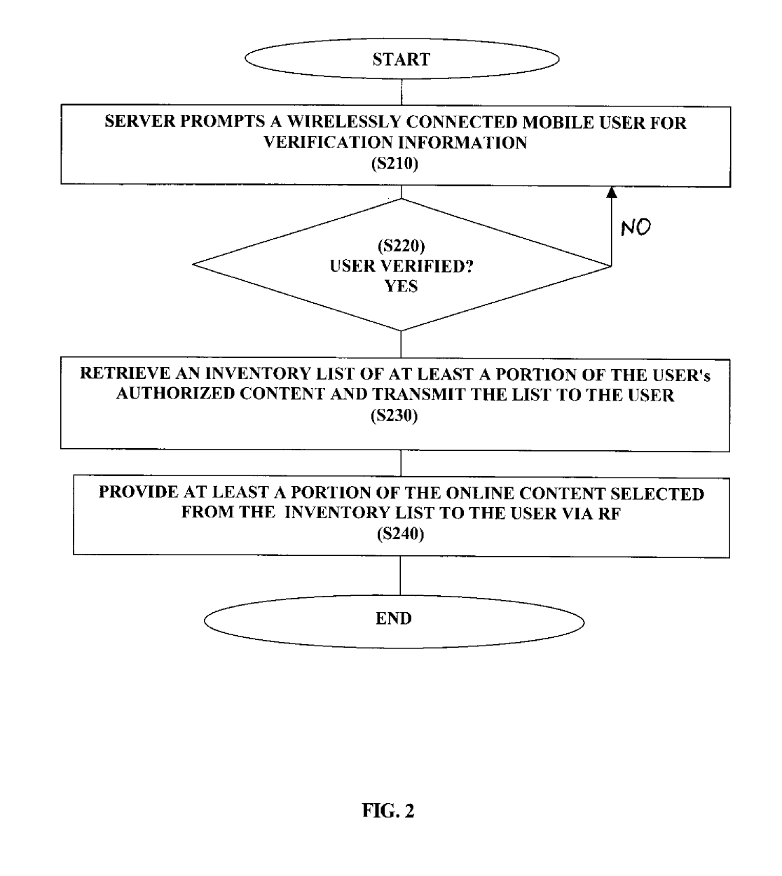

FIG. 2 comprises a flowchart providing some exemplary steps of a process according to the present invention. A person of ordinary skill in the art can appreciate that the steps are provided for illustrative purposes and the invention is not in any way limited to the exemplary actions shown in the flowchart.

At step 210, a wirelessly connected mobile user is prompted with verification information from a central server. For example, a wirelessly accessible player 123 shown in FIG. 1B may have been docked into a transmission means inside an automobile. Or a wirelessly accessible player was turned on or brought within an RF network (the Rf network can be any network, picocell, 700 MHZ sub-band, WiFi, whitespace bands between television channels, etc., just to name a few non-limiting examples). The player may have its own means to access the network, such as a keypad, or a prompt touched on the screen, etc. Typically, the server would provide a prompt for a username and/or password that is wirelessly transmitted to the docking means and/or the device.

At step 220, the server verifies the user, and if successful, provides an option menu that is provided to the user. Alternatively, the server may transmit a signal, such as a ready signal, that can be used by the device as a queue to activate a menu programmed into the user device. However, for communicating with the server a browser in a thin client device can be sufficient.

At step 230, the server retrieves an inventory list of at least a portion of a user's authorized content from at least one database accessible by the server. The inventory list is transmitted by the server to the user. A person of ordinary skill in the art will appreciate that the inventory list can be categorized in any desired, by title, artist, date purchased, date published, alphabetical order, reverse alphabetical order, random, etc.

At step 240, the server provides at least a portion of content selected from the inventory list. For example, a series of packets and/or data frames comprising the desired content is transmitted to the user. Alternatively, an automatic correlation can be provided, for example, by the server, so that the personalized inventory is loaded into the device. If the device has sufficient storage, the entire personalized inventory can be downloaded. Or the server can check what files are already present on the device and only download the missing or additional files.

Therefore, according to the process exemplified in FIG. 2, a user can access his/her personalized inventory anywhere, without having to carry the content around, or can download just what the user wants to access at a specific time. Additionally, a user may have multiple devices that are capable of being used to view/listen to the multimedia content, and in this way, even if someone borrows, rents or operates a second device, for example, on vacation or while away on business, their personalized content can be wirelessly loaded onto their device.

A person of ordinary skill in the art will appreciate that the invention includes that a user could user a wired connection to the server to download the content from virtually any location, as the server can also be accessible via the Internet besides being RF accessible.

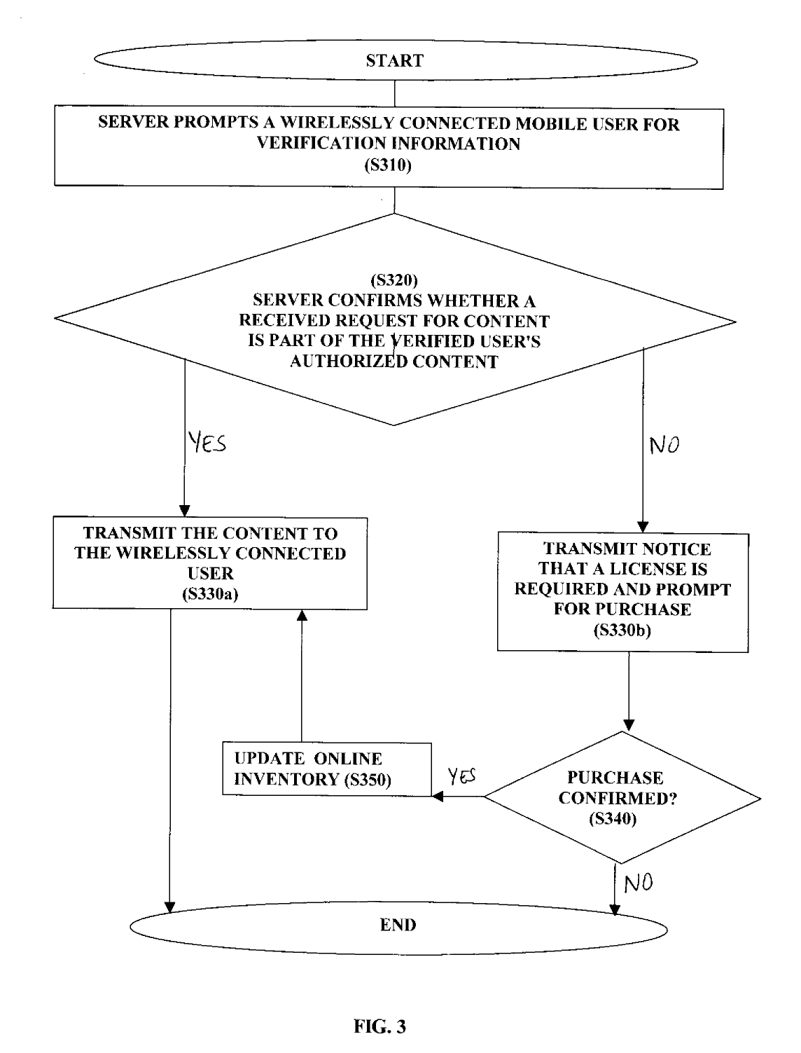

FIG. 3 is a flowchart that provides an exemplary process of a user desiring to add to the content of his/her personalized library. At step 310, a wirelessly accessed server performs a verification process to identify and authenticate user.

At step 320, the server responds to a request for a selected content by the server compares an inventory list of the user's personalized online library with a requested file to confirm the user has a license to download the material.

At step 330a, if the server determines that the material is licensed, the material is downloaded to the user. However, if the user requested material is not licensed, or the license must be renewed (such as quantifiably restricted licenses granted, for example, in Digital Rights Management (DRM)), the server provides the user with an opportunity to purchase or renew the license to access the content (step 330b).

At step 340, the server determines that the purchase is confirmed, and if affirmative, at step 350 updates the personalized content to add to the inventory list and then goes back to step 330a to provide the user with the now-licensed content and updates the personalized inventory list to indicate that the requested material is now part of the personalized online library. If the purchase is not confirmed, the process ends or the user may be re-prompted to require purchase or make a new selection. Thus, the user has not only downloaded the new material to his/her portable handheld device, but their online library now has been automatically updated.

With regard to the order shown in FIG. 3, the invention does not require that the online inventory is update prior to transmitting the newly purchased content. The order of whether to update simultaneously, before or after transmission is within the spirit of the invention and the scope of the appended claims. As discussed above, the flowcharts, as well as the other drawings, have been provided for illustrative purposes for a person of ordinary skill in the art and not to limit the invention to the examples shown and described.

It is also within the spirit and scope of the invention that while the examples discussed have the server transmit a prompt to the user, the server could transmit a command or signal that the user devices reads and retrieves a menu from storage.

A person of ordinary skill in the art can appreciate that unlike conventional devices that may allow a purchase from the device, the present invention eliminates the requirement of the user to have to upload the newly purchased content to their home or base computer, as the online inventory is updated after the purchase is confirmed without any action required by the user.

According to the present invention, a user can wirelessly access an online personalized library from virtually any wirelessly accessible device, or from connect to a wireless device (such as docking one's device into an interface in an automobile), so as to permit access to an entire personalized online catalog of content.

As the personalized content is online at a server, there is no need for the user to back up the files, and the user can access as much of the content as their wirelessly accessible device can handle, and can even load the content onto multiple devices. It is within the spirit and scope of the invention that a subscription fee could be charged periodically, or upon adding content, to provide wireless access one's personalized inventory of content.

Although a preferred embodiment of the invention has been illustrated and described, it will be obvious to those having skill in this art that various other forms and embodiments now may be visualized readily without departing significantly from the spirit and scope of the invention disclosed herein and set forth in the accompanying claims. For example, the control logic means and the receiver could be a single unit, or two separate units, and the demodulation may include decoding in addition to or in lieu of demodulation.

In addition, the above-described methods according to the present invention can be realized in hardware or as software or computer code that can be stored in a medium such as a ROM, an RAM, a floppy disk, a hard disk, or a magneto-optical disk or downloaded over a network, so that the methods described herein can be rendered in such software using a general purpose microprocessor, general purpose computer, or a special processor or in programmable or dedicated hardware, such as an ASIC or FPGA.

As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

What is claimed is:

1. A system for a personalized data catalog that is accessible by a mobile user device, comprising:
a server;
a database in communication with the server;
an online personalized inventory list of authorized content stored in one of said database or said server;
wireless transmission means for providing authorized content from the online personalized inventory to the mobile user;
wherein the server maintains and updates the online personalized inventory for access by the mobile user from any location in wireless communication with said wireless transmission means.

2. The system according to claim 1, wherein the mobile user device includes an interface comprising a transceiver means and a buffer.

3. The system according to claim 2, wherein the mobile user device includes a thin client device separate from the interface, and wherein the interface includes docketing means for connection with the thin client device, and wherein the thin client device communicates with the server for downloading authorized content of a least a portion of the online personalized inventory when docketed to the interface.

4. The system according to claim 3, the docketing means is arranged in an automobile.

5. The system according to claim 1, the authorized content in the online personalized inventory list comprises multimedia files.

6. The system according to claim 5, wherein the multimedia files comprise video games.

7. The system according to claim 5, wherein the multimedia files comprise at least copyrighted music and videos.

8. The system according to claim 5, wherein the authorized content includes personally stored data.

9. The system according to claim 1, wherein the wireless transmission means transmits the authorized content in the range of about 500 MHz to 800 MHz.

10. The system according to claim 1, wherein the wireless transmission means transmits the authorized content in the frequency range of whitespace between FCC licensed television channel frequencies.

11. A method for providing and maintaining a personalized inventory of authorized content, comprising:
(a) providing a database accessible by a server for retrieving, updating and/or maintaining at least a portion of authorized content from an online personalized inventory list of authorized content stored in one of the database or the server;
(b) prompting a wirelessly connected mobile user for verification information;
(c) upon verification of the wirelessly connected mobile user, transmitting a selection menu for a plurality of actions associated with the online personalized inventory list; and
(d) wirelessly transmitting at least a portion of the authorized content identified in the selection menu to the mobile user.

12. The method according to claim 11, wherein the server prompts the user to request content, compares the request with the online personalized inventory list to determine whether the content is authorized, and providing the user with an option to purchase a license for copyrighted content that is not a part of the online personalized inventory list.

13. The method according to claim 12, wherein the server updates the online personalized inventory list to add a newly purchased license of content as authorized content for subsequent access.

14. The method according to claim 11, wherein the content is wirelessly transmitted to the user via a frequency of about 500 MHz to 800 MHz.

15. The method according to claim 11, wherein the content is wirelessly transmitted to the user via a band of approximately a 700 MHz frequency.

16. The method according to claim 11, wherein the content is wirelessly transmitted to the user in the frequency range of white space between FCC licensed television channel frequencies.

17. The method according to claim 11, wherein the authorized content includes personally stored content.

18. The method according to claim 11, wherein the mobile user comprises a thin client device including a docketing interface with transceiving means, wherein the thin client device communicates with the server when docketed to the docketing interface.

19. The method according to claim 18, wherein the think client device communicates with the docketing interface via one of Bluetooth or Wifi.

20. The method according to the claim 11, wherein the authorized content comprises at least one of multimedia files and video games.
